(19) United States
(12) Patent Application Publication
(10) Pub. No.: US 2026/0238288 A1
(43) Pub. Date: Aug. 13, 2026

(54) JOINT BEAM REFINEMENT INDICATION FOR CHANNEL STATE INFORMATION REFERENCE SIGNAL RESOURCES

(71) Applicant: QUALCOMM Incorporated, San Diego, CA (US)

(72) Inventors: Qian ZHANG, Basking Ridge, NJ (US); Yan ZHOU, San Diego, CA (US); Changhwan PARK, San Diego, CA (US); Jae Ho RYU, San Diego, CA (US); Junyi LI, Greentown, PA (US)

(21) Appl. No.: 19/318,840

(22) Filed: Sep. 4, 2025

Related U.S. Application Data
(60) Provisional application No. 63/755,972, filed on Feb. 7, 2025.

(51) Int. Cl. H04B 7/06

(52) U.S. Cl. CPC H04B 7/0626; H04B 7/06952

(57) ABSTRACT

Various aspects of the present disclosure generally relate to wireless communication. In some aspects, a network node may transmit, and a user equipment (UE) may receive, a joint beam refinement indication that indicates whether periodic channel state information reference signal (CSI-RS) resources in a CSI-RS resource set are associated with a beam refinement procedure associated with both the UE and a network node. If the joint beam refinement indication indicates that the periodic CSI-RS resources in a CSI-RS resource set are associated with the beam refinement procedure associated with both the UE and the network node, the UE may sweep narrow reception beams when measuring signals associated with the periodic CSI-RS resources, such as by applying a different narrow reception beam in each periodic measurement period associated with the periodic CSI-RS resources or transmission a joint beam refinement report in accordance with the joint beam refinement indication.

### CROSS-REFERENCE TO RELATED APPLICATION

This Patent Application claims priority to U.S. Provisional Patent Application No. 63/755,972, filed on Feb. 7, 2025, entitled “JOINT BEAM REFINEMENT INDICATION FOR CHANNEL STATE INFORMATION REFERENCE SIGNAL RESOURCES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with a joint beam refinement indication for channel state information reference signal resources.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some wireless communication systems, various entities may perform beam management operations, such as periodic channel state information reference signal (CSI-RS) based transmit beam management procedures for layer 1 or layer 2 triggered mobility (LTM). In such procedures, a user equipment (UE) may report, to a network node, measurement results for a candidate cell, such as a synchronization signal/physical broadcast channel block resource indicator (SSBRI), a layer 3 reference signal received power (RSRP), or similar measurement results. In accordance with the measurement results, the network node may transmit signals associated with periodic CSI-RS resources within a CSI-RS resource set. The UE may apply a narrow reception beam to receive and measure the signals associated with the periodic CSI-RS resources in the same set and report the measurement results to the network node for further beam refinement for the LTM procedure.

### SUMMARY

The systems, methods, and devices of this disclosure each have several innovative aspects, no single one of which is solely responsible for the desirable attributes disclosed herein.

Some aspects described herein relate to a method for wireless communication by a user equipment (UE). The method may include receiving a joint beam refinement indication that indicates whether periodic channel state information reference signal (CSI-RS) resources in a CSI-RS resource set are associated with a beam refinement procedure associated with both the UE and a network node. The method may include transmitting a joint beam refinement report associated with the periodic CSI-RS resources in the CSI-RS resource set that is in accordance with the joint beam refinement indication.

Some aspects described herein relate to a method for wireless communication by a network node. The method may include transmitting, to a UE, a joint beam refinement indication that indicates whether periodic CSI-RS resources in a CSI-RS resource set are associated with a beam refinement procedure associated with both the UE and the network node. The method may include receiving, from the UE, a joint beam refinement report associated with the periodic CSI-RS resources in the CSI-RS resource set that is in accordance with the joint beam refinement indication.

Some aspects described herein relate to a UE. The UE may include a processing system. The processing system may include one or more processors and one or more code-storing memories coupled with the one or more processors. The processing system may be configured to cause the UE to receive a joint beam refinement indication that indicates whether periodic CSI-RS resources in a CSI-RS resource set are associated with a beam refinement procedure associated with both the UE and a network node. The processing system may be configured to cause the UE to transmit a joint beam refinement report associated with the periodic CSI-RS resources in the CSI-RS resource set that is in accordance with the joint beam refinement indication.

Some aspects described herein relate to a network node. The network node may include a processing system. The processing system may include one or more processors and one or more code-storing memories coupled with the one or more processors. The processing system may be configured to cause the network node to transmit, to a UE, a joint beam refinement indication that indicates whether periodic CSI-RS resources in a CSI-RS resource set are associated with a beam refinement procedure associated with both the UE and the network node. The processing system may be configured to cause the network node to receive, from the UE, a joint beam refinement report associated with the periodic CSI-RS resources in the CSI-RS resource set that is in accordance with the joint beam refinement indication.

Some aspects described herein relate to a non-transitory computer-readable medium that stores a set of instructions for wireless communication by a UE. The set of instructions, when executed by one or more processors of the UE, may cause the UE to receive a joint beam refinement indication that indicates whether periodic CSI-RS resources in a CSI-RS resource set are associated with a beam refinement procedure associated with both the UE and a network node. The set of instructions, when executed by one or more processors of the UE, may cause the UE to transmit a joint beam refinement report associated with the periodic CSI-RS resources in the CSI-RS resource set that is in accordance with the joint beam refinement indication.

Some aspects described herein relate to a non-transitory computer-readable medium that stores a set of instructions for wireless communication by a network node. The set of instructions, when executed by one or more processors of the network node, may cause the network node to transmit, to a UE, a joint beam refinement indication that indicates whether periodic CSI-RS resources in a CSI-RS resource set are associated with a beam refinement procedure associated with both the UE and the network node. The set of instructions, when executed by one or more processors of the network node, may cause the network node to receive, from the UE, a joint beam refinement report associated with the periodic CSI-RS resources in the CSI-RS resource set that is in accordance with the joint beam refinement indication.

Some aspects described herein relate to an apparatus for wireless communication. The apparatus may include means for receiving a joint beam refinement indication that indicates whether periodic CSI-RS resources in a CSI-RS resource set are associated with a beam refinement procedure associated with both the apparatus and a network node. The apparatus may include means for transmitting a joint beam refinement report associated with the periodic CSI-RS resources in the CSI-RS resource set that is in accordance with the joint beam refinement indication.

Some aspects described herein relate to an apparatus for wireless communication. The apparatus may include means for transmitting, to a UE, a joint beam refinement indication that indicates whether periodic CSI-RS resources in a CSI-RS resource set are associated with a beam refinement procedure associated with both the UE and the apparatus. The apparatus may include means for receiving, from the UE, a joint beam refinement report associated with the periodic CSI-RS resources in the CSI-RS resource set that is in accordance with the joint beam refinement indication.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating examples of channel state information reference signal (CSI-RS) beam management procedures.

FIG. 4 is a diagram illustrating an example of a layer 1/layer 2 triggered mobility procedure.

FIG. 5 is a diagram of an example associated with a joint beam refinement indication for CSI-RS resources.

FIG. 6 is a flowchart illustrating an example process performed, for example, at a user equipment (UE) or an apparatus of a UE that supports joint beam refinement procedures.

FIG. 7 is a flowchart illustrating an example process performed, for example, at a network node or an apparatus of a network node that supports joint beam refinement procedures.

FIG. 8 is a diagram of an example apparatus for wireless communication that supports joint beam refinement procedures.

FIG. 9 is a diagram of another example apparatus for wireless communication that supports joint beam refinement procedures.

### DETAILED DESCRIPTION

In some examples, beam management procedures, such as channel state information reference signal (CSI-RS) based beam management procedures, may be associated with a layer 1/layer 2 triggered mobility (LTM) procedure. For example, a network node and a user equipment (UE) may perform periodic CSI-RS based transmit beam management for LTM. In such examples, the UE may report synchronization signal/physical broadcast channel (SS/PBCH) block resource indicator (SSBRI) or layer 3 (L3) reference signal received power (RSRP) measurement results for a candidate cell. Based on the report, a network node may transmit signals using periodic CSI-RS resources within a CSI-RS resource set with repetition set to “off,” with the network node using a different narrow transmit beam that is associated with a reported best synchronization signal block (SSB) beam for each signal.

In some examples, for a purpose of network-node-side beam refinement, or otherwise, a UE may measure the signals transmitted via the periodic CSI-RS resources using one narrow reception beam. For example, the network node may periodically transmit the CSI-RSs, and, in each measurement period (e.g., each interval in which the CSI-RSs are transmitted by the network node or in which the UE is expected to measure the CSI-RSs, which may be configured via radio resource control (RRC) signaling such as via CSI-ResourceConfig or CSI-ReportConfig, among other examples), the UE may measure the signals using a same narrow reception beam. Thus, in a first measurement period, the network node may transmit signals using a first narrow transmit beam for a first CSI-RS, a second narrow transmit beam for a second CSI-RS, a third narrow transmit beam for a third CSI-RS, and so forth, with the narrow transmit beams being quasi-colocated with the best SSB previously reported by the UE. The UE may, in turn, measure all the CSI-RSs using a same narrow reception beam. Subsequently, in a next measurement period, the network node may again transmit signals using the first narrow transmit beam for a first CSI-RS, the second narrow transmit beam for a second CSI-RS, the third narrow transmit beam for a third CSI-RS, and so forth, and the UE may once again measure the CSI-RSs using the same narrow reception beam used in the previous measurement period. In this way, although the measurement results may be useful for beam refinement at the network node side, the measurement results may not be useful for UE-side beam refinement because the UE used the same narrow reception beam in each measurement period.

In some examples, it may thus be beneficial for the UE to sweep its narrow reception beams, such for a purpose of performing a joint beam refinement procedure (e.g., a procedure in which beam refinement is performed both at the network node side and the UE side). For example, it may be beneficial for the UE to apply a first narrow reception beam to measure signals in a first measurement period, to apply a second (e.g., different) narrow reception beam to measure signals in a second measurement period, to apply a third (e.g., different) narrow reception beam to measure signals in a third measurement period, and so forth, such that the UE may collect measurement results using various narrow reception beams, which may thus be used for both network-node-side and UE-side beam refinement. That is, in such examples, after one complete round of narrow reception beam sweeping over the periodic CSI-RSs in different measurement periods, the UE may have sufficient information to refine the UE's reception beam against all of the CSI-RS beams. However, there is currently no mechanism for the network node to indicate to the UE that the UE is to sweep narrow reception beams over the periodic CSI-RSs in different measurement periods or for the UE to report CSI-RS based measurements (e.g., layer 1 (L1) RSRP) after sweeping narrow reception beams over the periodic CSI-RSs in different measurement periods. Without such mechanisms, the UE may be unable to adequately perform UE-side beam refinement procedures in combination with network-node-side beam refinement procedures, resulting in high latency due to separate beam refinement procedures being performed for the network node and the UE, or otherwise communications between the network node and the UE that are performed using suboptimal beam pairs and thus degraded communication channels or a high incidence of communication errors leading to high computing, power, and network resource consumption for correcting communication errors.

Various aspects relate generally to joint beam refinement procedures for a UE and a network node. Some aspects more specifically relate to a joint beam refinement indication that indicates whether periodic CSI-RS resources in a CSI-RS resource set are associated with a joint beam refinement procedure. In some aspects, a network node may transmit, and a UE may receive, a joint beam refinement indication that indicates whether periodic CSI-RS resources in a CSI-RS resource set are associated with a beam refinement procedure associated with both the UE and a network node. If the joint beam refinement indication indicates that the periodic CSI-RS resources in a CSI-RS resource set are associated with the beam refinement procedure associated with both the UE and the network node, the UE may sweep narrow reception beams when measuring signals associated with the periodic CSI-RS resources, such as by applying a different narrow reception beam in each periodic measurement period associated with the periodic CSI-RS resources. The UE may transmit, and the network node may receive, a joint beam refinement report associated with the periodic CSI-RS resources in the CSI-RS resource set that is in accordance with the joint beam refinement indication, such as by indicating CSI-RS based L1-RSRP associated with multiple periodic measurement periods, among other information.

Particular aspects of the subject matter described in this disclosure can be implemented to realize one or more of the following potential advantages. In some examples, the described techniques can be used to enable improved LTM procedures, such as LTM procedures that are performed using optimized beam pairs, thereby reducing latency associated with LTM cell switching or otherwise resulting in less overhead for LTM procedures. Additionally or alternatively, the described techniques can be used to enable improve beamforming communications between a UE and network node by performing both network-node-side and UE-side beam refinement using a single periodic CSI-RS resource set, resulting in reduced communication errors and thus a reduction in computing, power, and network resource consumption otherwise required for correcting communication errors. Additionally or alternatively, the described techniques can be used to enable beam refinement at both the network node side and the UE side using a single periodic CSI-RS resource set, resulting in reduced overhead associated with configuring multiple CSI-RS resource sets for network-node-side beam refinement procedures and UE-side beam refinement procedures, respectively, resulting in more efficient usage of network resources and thus reduced latency and increased throughput.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

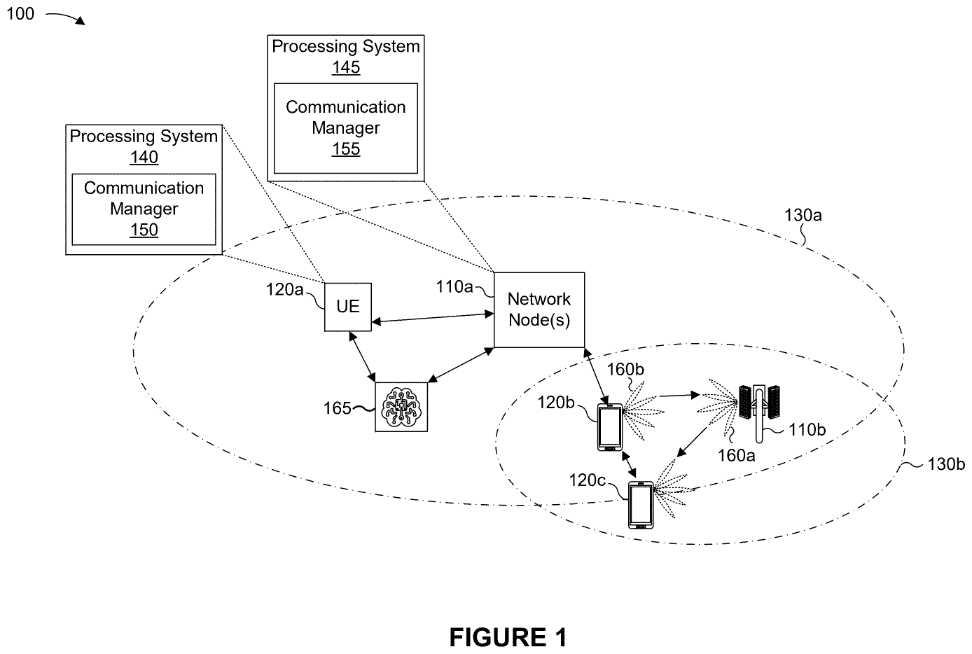

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, in accordance with a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified in accordance with different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) in accordance with changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SSBRI (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, in accordance with a geographical area where measurements are to be collected or UE capabilities to be used to collected measurements), or reporting configurations (for example, reporting parameters such as location, time, or sensor information, among other examples). Additionally or alternatively, the AI/ML model(s) may enable AI/ML procedures (for example, RAN-triggered service establishment, configuration, inferencing using UE-side or network-side models, performance monitoring or management, or capability signaling, among other examples). Additionally or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

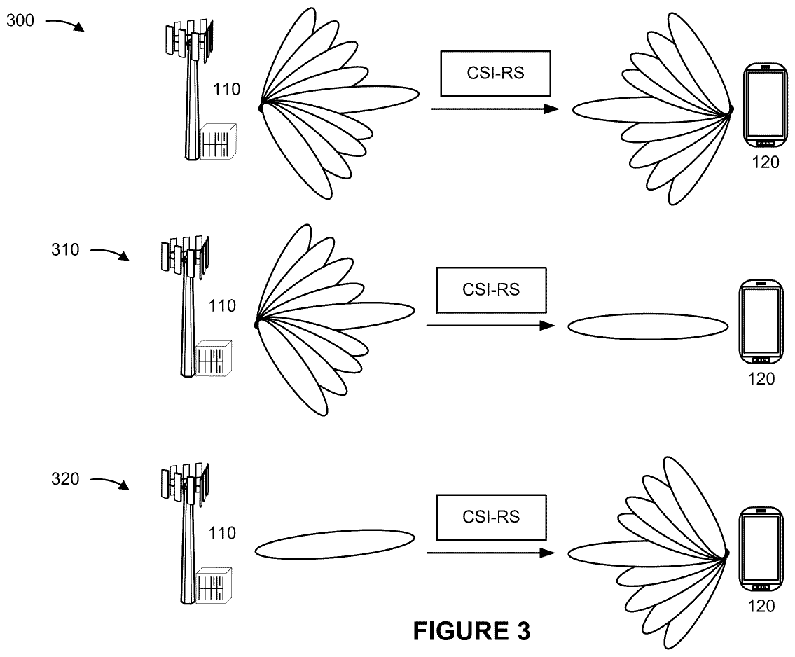

Further efficiencies in throughput, signal strength, or other signal properties may be achieved through beam refinement. For example, the network node 110 may be capable of communicating with the UE 120 using beams (for example, beam(s) 160a) of different beam widths. In some examples, the network node 110 may be configured to utilize a wider beam to communicate with the UE 120 when the UE 120 is in motion or for initial beam acquisition because wider coverage may increase the likelihood that the mobile UE 120 remains in coverage of the network node 110 while communicating using the wider beam. Conversely, the network node 110 may use a narrower beam to communicate with the UE 120 when the UE 120 is stationary because the network node 110 can reliably focus coverage on the UE 120 with low or minimal likelihood of the UE 120 moving out of the coverage area of the narrower beam. In some examples, to select a particular beam (for example, from the beam(s) 160a) for communication with a UE 120, the network node 110 may transmit a reference signal, such as an SSB or a CSI-RS, on each of a plurality of beams in a beam-sweeping manner. In some examples, SSBs may be transmitted on wider beams, whereas CSI-RSs may be transmitted on narrower beams. The UE 120 may measure the RSRP or the signal-to-interference-plus-noise ratio (SINR) on each of the beams and transmit a beam measurement report (for example, a Layer 1 (L1) measurement report) to the network node 110 indicating the RSRP or SINR associated with each of one or more of the measured beams. The network node 110 may then select the particular beam for communication with the UE 120 based on, or otherwise associated with, the L1 measurement report. In some other examples, when there is channel reciprocity between the uplink and the downlink, the network node 110 may derive the particular beam to communicate with the UE 120 (for example, on both the uplink and downlink) based on, or otherwise associated with, uplink measurements of one or more uplink reference signals, such as an SRS, transmitted by the UE 120. Examples of certain beam refinement procedures are described in more detail below in connection with FIG. 3.

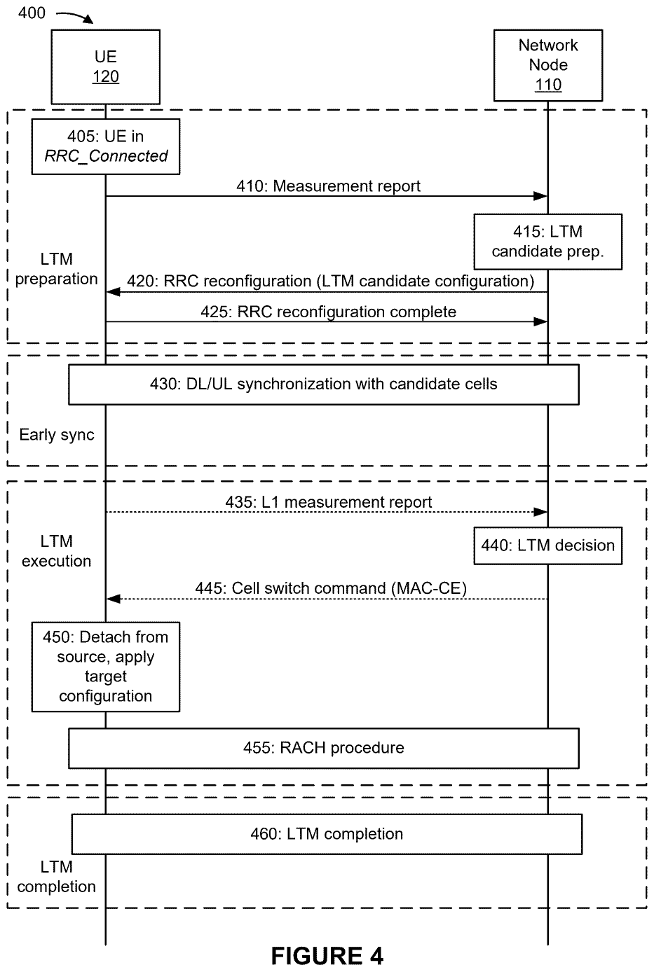

One enhancement for multi-beam operation at higher carrier frequencies is facilitation of efficient (for example, low latency and low overhead) downlink or uplink beam management operations to support Layer 1 or Layer 2 (L1/L2)-centric inter-cell mobility. L1/L2 signaling may be referred to as “lower layer” signaling. L1/L2 signaling may be used to activate or deactivate candidate cells in a set of cells configured for lower layer triggered mobility (LTM) or to provide reference signals for measurement by the UE 120, by which the UE 120 may select a candidate beam as a target beam for a lower layer handover operation. Accordingly, L1/L2-centric inter-cell mobility may enable a UE 120 to perform a cell switch via dynamic control signaling at lower layers (for example, DCI for L1 signaling or a MAC-CE for L2 signaling), rather than semi-static L3 RRC signaling. Thus, L1/L2 centric inter-cell mobility may reduce latency, reduce overhead, or otherwise increase efficiency of the cell switch. Examples of LTM procedures are described in more detail below in connection with FIG. 4.

In some aspects, the UE 120 may include a communication manager 150. As described in more detail elsewhere herein, the communication manager 150 may receive a joint beam refinement indication that indicates whether periodic CSI-RS resources in a CSI-RS resource set are associated with a beam refinement procedure associated with both the UE and a network node; and transmit a joint beam refinement report associated with the periodic CSI-RS resources in the CSI-RS resource set that is in accordance with the joint beam refinement indication. Additionally, or alternatively, the communication manager 150 may perform one or more other operations described herein.

In some aspects, the network node 110 may include a communication manager 155. As described in more detail elsewhere herein, the communication manager 155 may transmit, to a UE, a joint beam refinement indication that indicates whether periodic CSI-RS resources in a CSI-RS resource set are associated with a beam refinement procedure associated with both the UE and the network node; and receive, from the UE, a joint beam refinement report associated with the periodic CSI-RS resources in the CSI-RS resource set that is in accordance with the joint beam refinement indication. Additionally, or alternatively, the communication manager 155 may perform one or more other operations described herein.

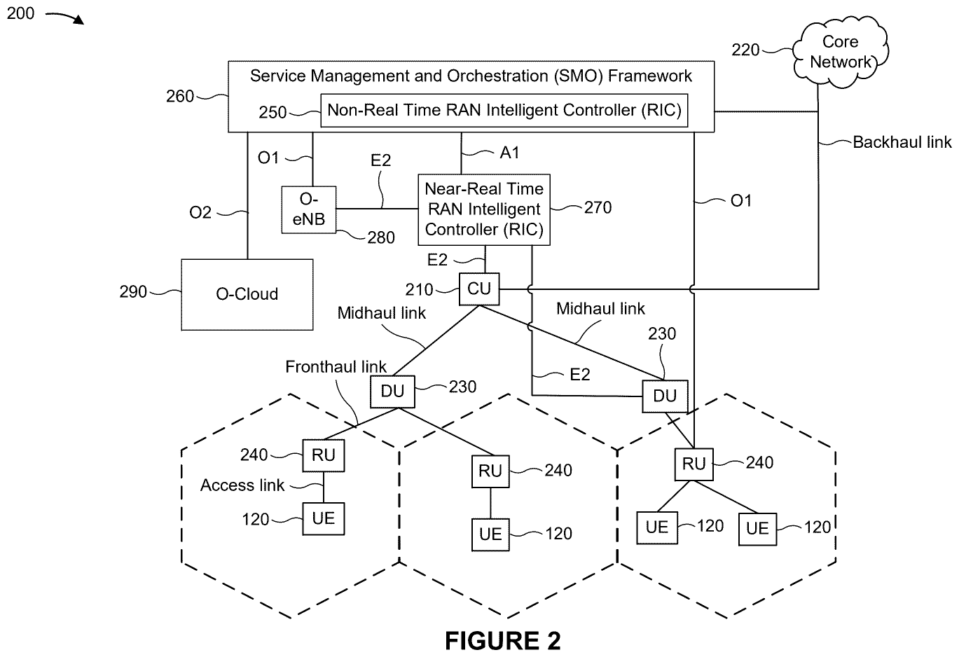

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

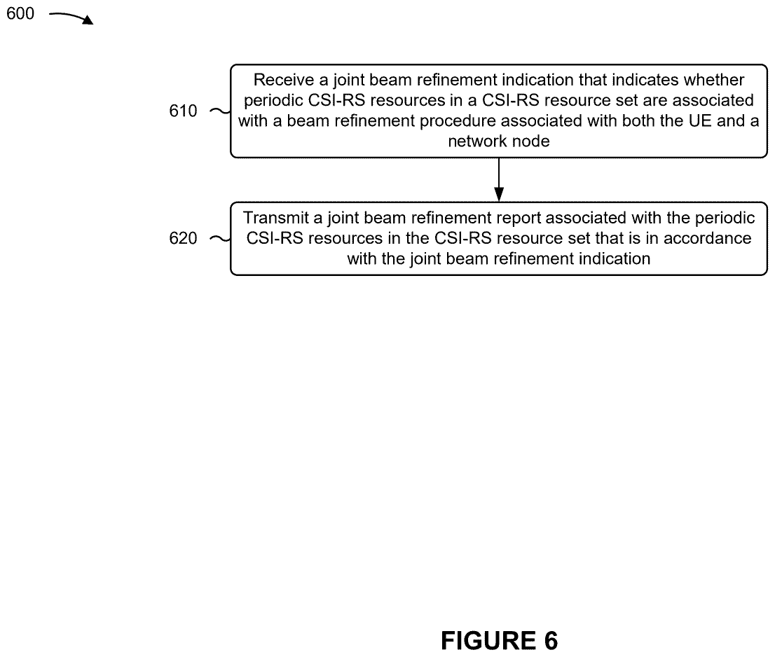

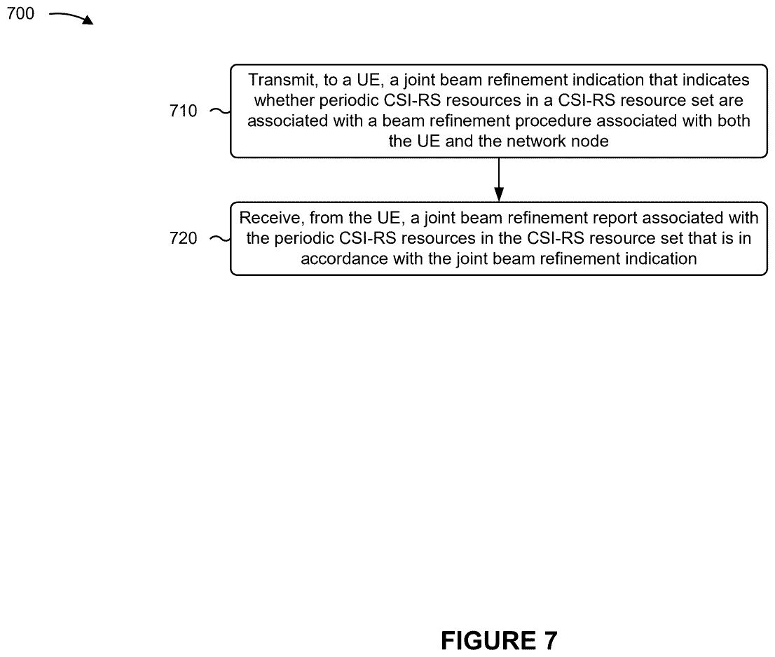

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with joint beam refinement procedures, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

FIG. 3 is a diagram illustrating examples 300, 310, and 320 of CSI-RS beam management procedures. As shown in FIG. 3, examples 300, 310, and 320 include a UE 120 in communication with a network node 110 in a wireless network (e.g., wireless communication network 100). However, the devices shown in FIG. 3 are provided as examples, and the wireless network may support communication and beam management between other devices (e.g., between a UE 120 and a network node 110 or TRP, between a mobile termination node and a control node, between an IAB child node and an IAB parent node, or between a scheduled node and a scheduling node). In some aspects, the UE 120 and the network node 110 may be in a connected state (e.g., an RRC connected state).

As shown in FIG. 3, example 300 may include a network node 110 (e.g., one or more network node devices such as an RU, a DU, or a CU, among other examples) and a UE 120 communicating to perform beam management using CSI-RSs. Example 300 depicts a first beam management procedure (e.g., P 1 CSI-RS beam management). The first beam management procedure may be referred to as a beam selection procedure, an initial beam acquisition procedure, a beam sweeping procedure, a cell search procedure, or a beam search procedure. As shown in FIG. 3 and example 300, CSI-RSs may be configured to be transmitted from the network node 110 to the UE 120. The CSI-RSs may be configured to be periodic (e.g., using RRC signaling), semi-persistent (e.g., using MAC-CE signaling), or aperiodic (e.g., using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 300 has been described in connection with CSI-RSs, the first beam management process may also use SSBs for beam management in a similar manner as described above.

As shown in FIG. 3, example 310 may include a network node 110 and a UE 120 communicating to perform beam management using CSI-RSs. Example 310 depicts a second beam management procedure (e.g., P2 CSI-RS beam management). The second beam management procedure may be referred to as a beam refinement procedure, a network node beam refinement procedure, a TRP beam refinement procedure, or a transmit beam refinement procedure. As shown in FIG. 3 and example 310, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 3, example 320 depicts a third beam management procedure (e.g., P3 CSI-RS beam management). The third beam management procedure may be referred to as a beam refinement procedure, a UE beam refinement procedure, or a receive beam refinement procedure. As shown in FIG. 3 and example 320, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure or the second beam management procedure). The third beam management procedure may enable the network node 110 or the UE 120 to select a best receive beam based at least in part on reported measurements received from the UE 120 (e.g., of the CSI-RS of the transmit beam using the one or more receive beams).

As indicated above, FIG. 3 is provided as an example of beam management procedures. Other examples of beam management procedures may differ from what is described with respect to FIG. 3. For example, the UE 120 and the network node 110 may perform the third beam management procedure before performing the second beam management procedure, or the UE 120 and the network node 110 may perform a similar beam management procedure to select a UE transmit beam.

FIG. 4 is a diagram illustrating an example 400 of an LTM procedure.

In some examples, a network node 110 may instruct a UE 120 to change serving cells, such as when the UE 120 moves away from coverage of a current serving cell (sometimes referred to as a source cell) and towards coverage of a neighboring cell (sometimes referred to as a target cell). In some examples, the network node 110 may instruct the UE 120 to change cells using an L3 handover procedure. An L3 handover procedure may include the network node 110 transmitting, to the UE 120, an RRC reconfiguration message indicating that the UE 120 should perform a handover procedure to a target cell, which may be transmitted in response to the UE 120 providing the network node 110 with an L3 measurement report indicating signal strength measurements associated with various cells (e.g., measurements associated with the source cell and one or more neighboring cells). In response to receiving the RRC reconfiguration message, the UE 120 may communicate with the source cell and the target cell to detach from the source cell and connect to the target cell (e.g., the UE 120 may establish an RRC connection with the target cell). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

L3 handover procedures may be associated with high latency and high overhead due to the multiple RRC reconfiguration messages or other L3 signaling and operations used to perform the handover procedures. Accordingly, in some examples, a UE 120 may be configured to perform a lower-layer (e.g., L1 or L2) handover procedure, sometimes referred to an LTM procedure, such as the example 400 LTM procedure shown in FIG. 4. As shown in FIG. 4, the LTM procedure may include four phases: an LTM preparation phase, an early synchronization phase (shown as “early sync” in FIG. 4), an LTM execution phase, or an LTM completion phase.

In a first operation 405, during the LTM preparation phase the UE 120 may be in an RRC connected state (sometimes referred to as RRC_Connected) with a source cell. In a second operation 410, the UE 120 may transmit, and the network node 110 may receive, a measurement report (sometimes referred to as a MeasurementReport), which may be an L3 measurement report. The measurement report may indicate signal strength measurements (e.g., RSRP, RSSI, RSRQ, or CQI) or similar measurements associated with the source cell or one or more neighboring cells. In some examples, based at least in part on the measurement report or other information, the network node 110 may decide to use LTM, and thus, in a third operation 415, the network node 110 may initiate LTM candidate preparation.

In a fourth operation 420, the network node 110 may transmit, and the UE 120 may receive, an RRC reconfiguration message (sometimes referred to as an RRCReconfiguration message), which may include an LTM candidate configuration. More particularly, the RRC reconfiguration message may indicate a configuration of one or more LTM candidate target cells, which may be candidate cells to become a serving cell of the UE or cells for which the UE 120 may later be triggered to perform an LTM procedure. In a fifth operation 425, the UE 120 may store the configuration of the one or more LTM candidate cell configurations and, in response, may transmit, to the network node 110, an RRC reconfiguration complete message (sometimes referred to as an RRCReconfigurationComplete message).

In a sixth operation 430, during the early synchronization phase the UE 120 may optionally perform downlink/uplink synchronization with the candidate cells associated with the one or more LTM candidate cell configurations. For example, the UE 120 may perform downlink synchronization and timing advance acquisition with the one or more candidate target cells prior to receiving an LTM switch command (which is described in more detail below in connection with the ninth operation 445). In some aspects, performing the early synchronization with the one or more candidate cells may reduce latency associated with performing a random access channel (RACH) procedure later in the LTM procedure, which is described in more detail below in connection with the eleventh operation 455.

In a seventh operation 435, during the LTM execution phase the UE 120 may perform L1 measurements on the configured LTM candidate target cells, and thus may transmit, to the network node 110, lower-layer (e.g., L1) measurement reports. In an eighth operation 440, based at least in part on the lower-layer measurement reports, the network node 110 may decide to execute an LTM cell switch to a target cell. Accordingly, in a ninth operation 445, the network node 110 may transmit, and the UE 120 may receive, a MAC-CE or similar message triggering an LTM cell switch (the MAC-CE or similar message is sometimes referred to herein as a cell switch command). The cell switch command may include an indication of a candidate configuration index associated with the target cell. In a tenth operation 450, based at least in part on receiving the cell switch command, the UE 120 may switch to the configuration of the LTM candidate target cell (e.g., the UE 120 may detach from the source cell and apply the target cell configuration). Moreover, in an eleventh operation 455, the UE 120 may perform a RACH procedure towards the target cell, such as when a timing advance associated with the target cell is not available (e.g., in examples in which the UE 120 did not perform the early synchronization as described above in connection with the sixth operation 430).

In a twelfth operation 460, during the LTM completion phase the UE 120 may indicate successful completion of the LTM cell switch towards the target cell. In this way, cell switch to a target cell may be performed using less overhead than for an L3 handover procedure or a cell switch to a target cell may be associated with reduced latency as compared to L3 handover procedure.

In some examples, one or more beam management procedures (e.g., one or more of the CSI-RS based beam management procedures described above in connection with FIG. 3) may be associated with an LTM procedure (e.g., the example 400 LTM procedure shown in FIG. 4). For example, a network node and a UE may perform periodic CSI-RS based P2 beam management for LTM. In such examples, the UE may report SSBRI or L3-RSRP measurement results (which may correspond to the measurement report described above in connection with the second operation 410), among other examples, for a candidate cell. Based on, or otherwise associated with, the report, a network node may transmit signals using periodic CSI-RS resources within a CSI-RS resource set with repetition set to “off” and with the network node using, for each signal, a different narrow transmit beam that is associated with a reported best SSB beam. The UE may apply a narrow reception beam to receive all of the CSI-RS resources in the same set and, in the next periodic measurement period, the UE may apply another narrow reception beam to receive the CSI-RS resources. In this regard, after one complete round of narrow reception beam sweeping over the periodic CSI-RSs in different measurement periods, the UE may have sufficient information to refine the UE's reception beam against all of the CSI-RS beams. However, there is currently no mechanism for the network node to indicate to the UE that the UE is to sweep narrow reception beams over the periodic CSI-RSs in different measurement periods or for the UE to report CSI-RS based measurements (e.g., L1-RSRP) based on, or otherwise associated with, the UE sweeping narrow reception beams over the periodic CSI-RSs in different measurement periods. In this regard, the UE may be unable to adequately perform UE-side beam refinement procedures or related reporting based on a single configured CSI-RS resource set, resulting in high latency or otherwise inefficient beam refinement procedures, or communications between the network node and the UE that are performed using suboptimal beam pairs and thus with degraded communication channels and a high incidence of communication errors, resulting in high computing, power, and network resource consumption for correcting communication errors.

Some aspects and techniques described herein enable joint beam refinement procedures at a network node and UE using a single CSI-RS resource set, such as for a purpose of performing improved LTM or similar procedures. In some aspects, a network node may transmit, and a UE may receive, a joint beam refinement indication that indicates whether periodic CSI-RS resources in a CSI-RS resource set are associated with a beam refinement procedure associated with both the UE and a network node. If the joint beam refinement indication indicates that the periodic CSI-RS resources are associated with the beam refinement procedure associated with both the UE and the network node, the UE may sweep narrow reception beams when measuring signals associated with the periodic CSI-RS resources, such as by applying a different narrow reception beam in each periodic measurement period associated with the periodic CSI-RS resources. After the multiple measurement periods (e.g., after the UE has fully measured signals using all narrow reception beams associated with the UE), the UE may transmit, and the network node may receive, a joint beam refinement report, which may indicate CSI-RS based L1-RSRP, among other information. As a result, the techniques and aspects described herein may enable improved LTM procedures and/or enhanced communication channels, resulting in reduced latency, increased bandwidth, or reduced communication errors, and thus a reduction in computing, power, and network resource consumption otherwise required for correcting communication errors.

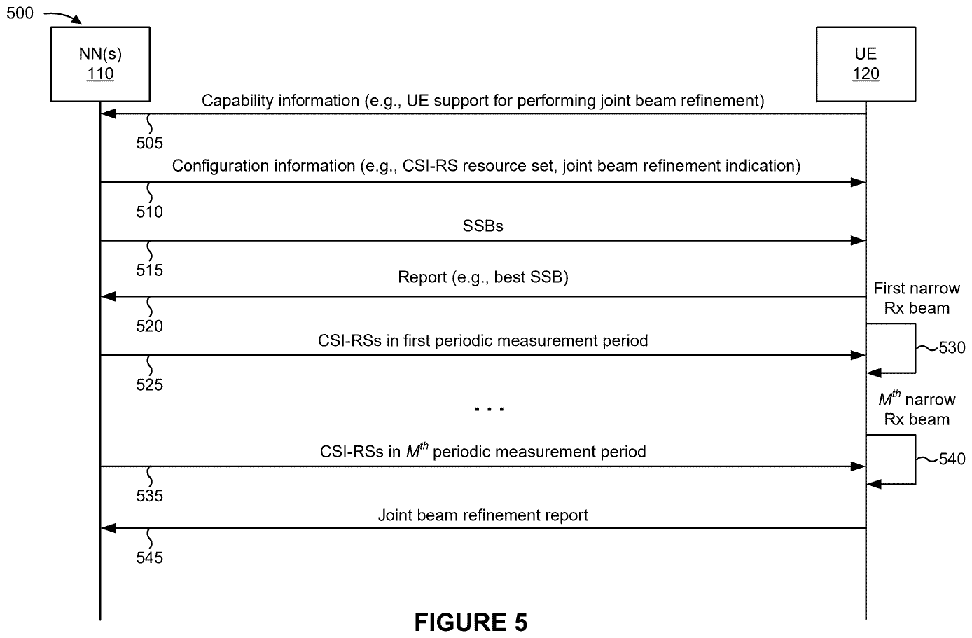

FIG. 5 is a diagram of an example 500 associated with a joint beam refinement indication for CSI-RS resources. As shown in FIG. 5, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 5. In some aspects, the network node 110 and the UE 120 may be associated with beamforming communications or may be capable of performing one or more CSI-RS beam management procedures, such as one or more of the beam management procedures described above in connection with FIG. 3.

In a first operation 505, the UE 120 may transmit, and the network node 110 may receive, capability information. The capability information may be included in a capability report. The UE 120 may transmit the capability information via an uplink communication, a sidelink communication, a unicast communication, a broadcast communication, a UE assistance information (UAI) communication, a UCI communication, a sidelink control information (SCI) communication, a MAC-CE communication, an RRC communication, a PUCCH, a PUSCH, a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter for performing joint beam refinement procedures. As another example, the capability information may indicate a capability or parameter for performing LTM procedures. One or more operations described herein may be based on, or otherwise associated with, capability information. For example, the UE 120 may perform a communication in accordance with the capability information, or may receive configuration information that is in accordance with the capability information. In some aspects, the capability information may indicate UE support for receiving a joint beam refinement indication (described in more detail below in connection with the second operation 510) or transmitting a joint beam refinement report (described in more detail below in connection with the ninth operation 545). Additionally or alternatively, the capability information may indicate a quantity of narrow reception beams to be used by the UE 120 for a joint beam refinement procedure (described in more detail below in connection with the fifth operation 525 through the eighth operation 540), among other information.

In a second operation 510, the network node 110 may transmit, and the UE 120 may receive, configuration information. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC-CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may configure periodic CSI-RS resources in a CSI-RS resource set to be used for a beam refinement procedure, such as one of the beam refinement procedures described above in connection with FIG. 3 or a similar beam refinement procedure. Additionally or alternatively, the configuration information may include a joint beam refinement indication that indicates whether the periodic CSI-RS resources in the CSI-RS resource set are associated with a joint beam refinement procedure (e.g., a beam refinement procedure that is associated with both the UE 120 and the network node 110).

More particularly, in some aspects the joint beam refinement indication may be associated with a one-bit indicator in a CSI-RS resource set IE received via RRC signaling that indicates whether a same spatial filter is to be applied for the periodic CSI-RS resources in the CSI-RS resource set across multiple periodic measurement periods. In such aspects, if the joint beam refinement indication indicates that a same spatial filter is to be applied for the periodic CSI-RS resources in the CSI-RS resource set across multiple periodic measurement periods, the joint beam refinement indication may be indicative that the UE 120 is to apply different narrow beams for UE-side beam refinement across different periodic measurement periods of the periodic CSI-RS resources in the CSI-RS resource set. For example, in aspects in which the UE 120 is associated with M narrow reception beams (which, in some aspects, may be indicated via the capability information described above in connection with the first operation 505), after M periodic measurement periods the UE 120 may identify the best beam pair and may report the associated transmit beam to the network node 110 or save the corresponding reception beam for downlink reception. On the other hand, if the joint beam refinement indication indicates that a same spatial filter is not to be applied for the periodic CSI-RS resources in the CSI-RS resource set across multiple periodic measurement periods, the joint beam refinement indication may be indicative that the UE is to apply a same narrow beam across different periodic measurement periods of the periodic CSI-RS resources in the CSI-RS resource set (e.g., the UE 120 may be notified that the CSI-RS resources in the CSI-RS resource set are to be used only for network-node-side beam refinement procedures).

In some other aspects, the joint beam refinement indication may be associated with a field (sometimes referred to herein as a purpose field) in a CSI-RS resource set IE received via RRC signaling that indicates whether the periodic CSI-RS resources in the CSI-RS resource set are associated with the beam refinement procedure associated with both the UE 120 and the network node 110, or else only associated with network node 110. Put another way, the CSI-RS resource set IE may include a purpose field or similar field that indicates one of “network node side beam refinement only” or “joint network node side and UE side beam refinement,” among other examples. In such aspects, if the purpose field indicates “joint network node side and UE side beam refinement,” the UE 120 may be notified to apply different narrow beams for UE 120 side beam refinement across different periodic measurement periods of the periodic CSI-RS resources in the CSI-RS resource set. For example, in aspects in which the UE 120 is associated with M narrow reception beams, after M periodic measurement periods the UE 120 may identify the best beam pair and may report the associated transmit beam to the network node 110 or save the corresponding reception beam for downlink reception. On the other hand, if the purpose field indicates “network node side beam refinement only,” the UE 120 may be notified to apply a same narrow beam across different periodic measurement periods of the periodic CSI-RS resources in the CSI-RS resource set (e.g., the UE 120 may be notified that the CSI-RS resources in the CSI-RS resource set are to be used only for network-node-side beam refinement procedures).

In some aspects, the configuration information may further indicate a reporting period associated with the joint beam refinement report. For example, the configuration information may indicate that a reporting period is associated with multiple periodic measurement periods for the periodic CSI-RS resources in the CSI-RS resource set, such that the UE 120 may measure signals associated with the CSI-RS resources using multiple narrow reception beams. More particularly, in traditional CSI-RS based beam management procedures, a UE may be configured to always report a best transmit beam based on a latest measurement of all narrow CSI-RS beams using a fixed UE reception beam. However, in order to enable the joint beam refinement procedures described herein, the configuration information may configure a reporting period that spans multiple periodic measurement periods, so that the UE 120 may sweep through multiple narrow reception beams (as described in more detail below in connection with the fifth operation 525 through the eighth operation 540) and then transmit the joint beam refinement report after sweeping through all narrow reception beams. In that regard, in aspects in which the UE 120 is associated with a quantity of narrow reception beams (e.g., M reception beams), a quantity of the multiple periodic measurement periods associated with the reporting period may be greater than or equal to a quantity of the multiple narrow reception beams (e.g., the reporting period may include at least M periodic measurement periods).

In such aspects, the UE 120 may indicate the quantity of narrow reception beams associated with the UE 120, such as via the capability information described above in connection with the first operation 505, and the network node 110 may configure the reporting period in accordance with the capability information. Put another way, in some aspects the UE 120 may report a new UE capability of supported M reception beam refinement periods (with M corresponding to the quantity of narrow reception beams associated with the UE 120, as described above) and, in accordance with the UE capability information, the network node 110 may configure a reporting period that is greater than or equal to M measurement periods to enable the UE 120 to report the joint network node and UE beam refinement results.

The UE 120 may configure itself based at least in part on the configuration information. In some aspects, the UE 120 may be configured to perform one or more operations described herein based at least in part on the configuration information.

In some aspects, signals (e.g., pilot signals) to be transmitted by the network node 110 via the CSI-RS resources in the CSI-RS resource set may be based at least in part on a previously reported best SSB for a candidate cell. For example, in some aspects the network node 110 may use narrow transmit beams that are QCLed with the previously reported best SSB beam when transmitting signals using the CSI-RS resources. In such aspects, in a third operation 515, the network node 110 may transmit, and the UE 120 may receive, one or more SSBs and, in a fourth operation 520, the UE 120 may transmit, and the network node 110 may receive, a report indicating a best SSB (e.g., an SSB associated with a highest measurement result, among other examples). More particularly, in some aspects the UE 120 may report SSBRI or L3-RSRP measurement results, among other information, for a best SSB beam for a candidate cell, and the network node 110 may transmit signals using a quantity of periodic CSI-RS resources (e.g., N periodic CSI-RS resources) using N narrow beams that are QCLed to the best SSB beam indicated by the UE 120 (as described in more detail below in connection with the fifth operation through the eighth operation 540).

In some aspects, based at least in part on the configuration information and/or the joint beam refinement indication (more particularly, based at least in part on the one-bit indicator indicating that the same spatial filter is to be applied for the periodic CSI-RS resources in the CSI-RS resource set across the multiple periodic measurement periods or based at least in part on the purpose field indicating that the periodic CSI-RS resources in the CSI-RS resource set are associated with the beam refinement procedure associated with both the UE and the network node), the network node 110 and the UE 120 may perform a joint beam refinement procedure in which the UE 120 applies a different narrow reception beam in each periodic measurement period associated with the CSI-RS resources. More particularly, in a fifth operation 525, the network node 110 may transmit, and the UE 120 may receive, signals using CSI-RS resources in a first periodic measurement period associated with the CSI-RS resource set. The network node 110 may transmit the signals by sweeping through transmit beams, such as N narrow transmit beams that are QCLed to the best SSB reported via the report described above in connection with the fourth operation 520. For example, in the fifth operation 525, the network node 110 may transmit a first signal using a first narrow transmit beam that is QCLed to the best SSB beam, the network node 110 may transmit a second signal using a second narrow transmit beam that is QCLed to the best SSB beam, and so forth through an N^{th} signal using an N^{th} narrow transmit beam that is QCLed to the best SSB beam, among other examples. Moreover, in a sixth operation 530 the UE 120 may receive each of the N signals using a first narrow reception beam, of M narrow reception beams associated with UE 120. The process may repeat in a like manner but with the UE 120 using a different narrow reception beam in each measurement period, such that in a second measurement period, the UE 120 receives the N signals using a second of the M narrow reception beams associated with UE 120, in a third measurement period, the UE 120 receives the N signals using a third of the M narrow reception beams associated with UE 120, and so forth through an M^{th} measurement period (as shown in connection with a seventh operation 535) in which the UE 120 receives the N signals using the M^{th} beam of the M narrow reception beams associated with UE 120 (as shown in connection with an eighth operation 540).

As described above, the N signals transmitted by the network node 110 may be QCLed to the best SSB beam reported via the report described above in connection with the fourth operation 520. Moreover, in some aspects, the M narrow reception beams used by the UE 120 to receive the signals in the various measurement periods may be QCLed to the best SSB beam reported via the report described above in connection with the fourth operation 520. Accordingly, in some aspects the network node 110 may reconfigure the CSI-RS resources (e.g., via an RRC reconfiguration message) after receiving an indication of the best SSB beam, such as for a purpose of ensuring that all periodic CSI-RS resources in the CSI-RS resource set are QCLed (e.g., QCLed type D, sometimes referred to herein simply as QCL-D) to the best SSB beam. However, in some other aspects, the UE 120 may apply the QCL-D to the best SSB beam without receiving an RRC reconfiguration message or similar communication. Put another way, in some aspects the UE 120 may implicitly apply the same QCL-D as the reported best SSB beam of the TCI state after reporting SSBRI or L3-RSRP measurement results for a best SSB beam for a candidate cell. In such aspects, latency associated with the beam refinement procedures may be reduced, as compared to procedures in which the network node 110 reconfigures the CSI-RS resources (e.g., via an RRC reconfiguration message) after receiving an indication of the best SSB beam.

In a ninth operation 545, based on, or otherwise associated with, receiving and/or measuring the signals via the multiple periodic measurement periods, the UE 120 may transmit a joint beam refinement report. For example, the UE 120 may identify a best transmit/reception beam pair (with the best transmit beam being one of the N narrow transmit beams used to transmit signals in the various measurement periods and with the best receive beam being one of the M narrow reception beams used to receive signals in the various measurement periods), and the UE 120 may indicate the best transmit beam to be used for an LTM procedure or similar procedure to the network node 110 via the ninth operation 545. Moreover, the UE 120 may save an indication of the best reception beam, such that the UE 120 may later use the best reception beam when performing an LTM procedure associated with the network node 110 (e.g., when triggered by the network node 110 in a similar manner as described above in connection with the ninth operation 445 in FIG. 4), among other examples.

Based at least in part on the network node 110 transmitting the joint beam refinement indication and the UE 120 transmitting the joint beam refinement report, the UE 120 and/or the network node 110 may conserve computing, power, network, and/or communication resources that may have otherwise been consumed by traditional beam refinement or LTM procedures. For example, based at least in part on the network node 110 transmitting the joint beam refinement indication and the UE 120 transmitting joint beam refinement report, the UE 120 and the network node 110 may communicate with improved beam pairs and thus with a reduced error rate, which may conserve computing, power, network, and/or communication resources that may have otherwise been consumed to detect and/or correct communication errors.

FIG. 6 is a flowchart illustrating an example process 600 performed, for example, at a UE or an apparatus of a UE that supports joint beam refinement procedures. Example process 600 is an example where the apparatus or the UE (for example, UE 120) performs operations associated with a joint beam refinement indication for CSI-RS resources.

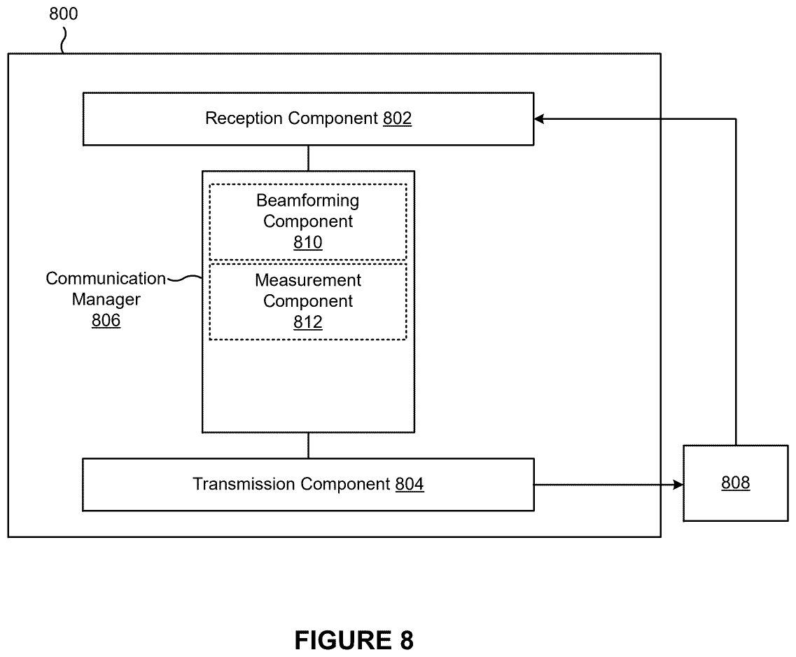

As shown in FIG. 6, in some aspects, process 600 may include receiving a joint beam refinement indication that indicates whether periodic CSI-RS resources in a CSI-RS resource set are associated with a beam refinement procedure associated with both the UE and a network node (block 610). For example, the UE (such as by using communication manager 806 or reception component 802, depicted in FIG. 8) may receive a joint beam refinement indication that indicates whether periodic CSI-RS resources in a CSI-RS resource set are associated with a beam refinement procedure associated with both the UE and a network node, as described above.

As further shown in FIG. 6, in some aspects, process 600 may include transmitting a joint beam refinement report associated with the periodic CSI-RS resources in the CSI-RS resource set that is in accordance with the joint beam refinement indication (block 620). For example, the UE (such as by using communication manager 806 or transmission component 804, depicted in FIG. 8) may transmit a joint beam refinement report associated with the periodic CSI-RS resources in the CSI-RS resource set that is in accordance with the joint beam refinement indication, as described above.

Process 600 may include additional aspects, such as any single aspect or any combination of aspects described below or in connection with one or more other processes described elsewhere herein.

In a first additional aspect, the joint beam refinement indication is associated with a one-bit indicator in a CSI-RS resource set information element received via radio resource control signaling that indicates whether a same spatial filter is to be applied for the periodic CSI-RS resources in the CSI-RS resource set across multiple periodic measurement periods.

In a second additional aspect, alone or in combination with the first aspect, the one-bit indicator indicates that the same spatial filter is to be applied for the periodic CSI-RS resources in the CSI-RS resource set across the multiple periodic measurement periods, and the joint beam refinement report is associated with the UE applying a different narrow reception beam, of multiple narrow reception beams associated with the UE, in each periodic measurement period, of the multiple periodic measurement periods.

In a third additional aspect, alone or in combination with one or more of the first and second aspects, the joint beam refinement indication is associated with a field in a CSI-RS resource set information element received via radio resource control signaling that indicates whether the periodic CSI-RS resources in the CSI-RS resource set are associated with the beam refinement procedure associated with both the UE and the network node or only associated with network node.

In a fourth additional aspect, alone or in combination with one or more of the first through third aspects, the field indicates that the periodic CSI-RS resources in the CSI-RS resource set are associated with the beam refinement procedure associated with both the UE and the network node, and the joint beam refinement report is associated with the UE applying a different narrow reception beam, of multiple narrow reception beams associated with the UE, in each periodic measurement period, of multiple periodic measurement periods associated with the periodic CSI-RS resources in the CSI-RS resource set.

In a fifth additional aspect, alone or in combination with one or more of the first through fourth aspects, process 600 includes receiving configuration information indicating a reporting period associated with the joint beam refinement report, wherein the reporting period is associated with multiple periodic measurement periods for the periodic CSI-RS resources in the CSI-RS resource set.

In a sixth additional aspect, alone or in combination with one or more of the first through fifth aspects, the UE is associated with multiple narrow reception beams, and a quantity of the multiple periodic measurement periods is greater than or equal to a quantity of the multiple narrow reception beams.

In a seventh additional aspect, alone or in combination with one or more of the first through sixth aspects, process 600 includes transmitting capability information indicating a quantity of narrow reception beams associated with the UE, wherein the reporting period is in accordance with the capability information.

In an eighth additional aspect, alone or in combination with one or more of the first through seventh aspects, process 600 includes transmitting another report indicating a best SSB beam associated with the network node, wherein the joint beam refinement report is in accordance with the UE applying, after transmitting the other report, narrow reception beams quasi-colocated to the best SSB beam indicated by the other report.

In a ninth additional aspect, alone or in combination with one or more of the first through eighth aspects, process 600 includes transmitting another report indicating a best SSB beam associated with the network node, wherein the periodic CSI-RS resources are quasi-colocated to the best SSB beam.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a flowchart illustrating an example process 700 performed, for example, at a network node or an apparatus of a network node that supports joint beam refinement procedures. Example process 700 is an example where the apparatus or the network node (for example, network node 110) performs operations associated with a joint beam refinement indication for CSI-RS resources.

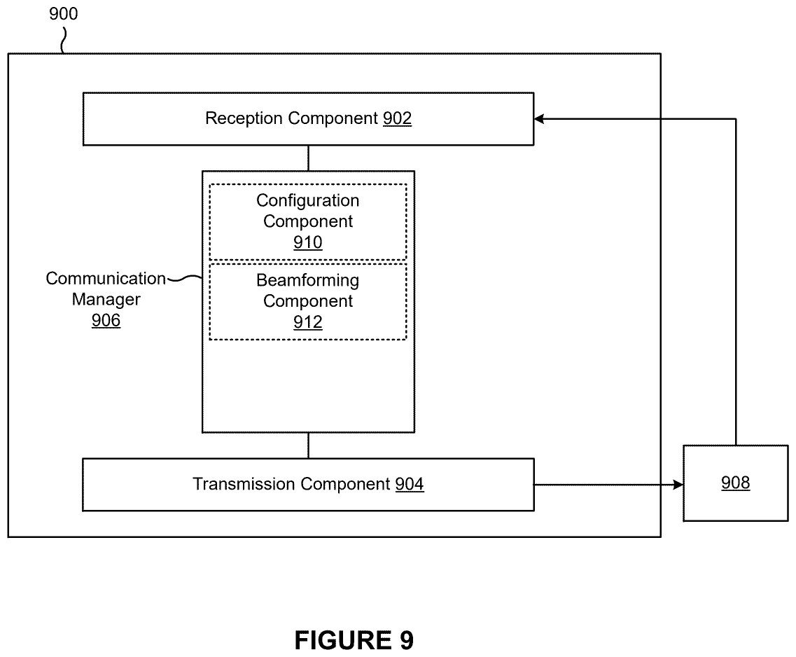

As shown in FIG. 7, in some aspects, process 700 may include transmitting, to a UE, a joint beam refinement indication that indicates whether periodic CSI-RS resources in a CSI-RS resource set are associated with a beam refinement procedure associated with both the UE and the network node (block 710). For example, the network node (such as by using communication manager 150 or transmission component 904, depicted in FIG. 9) may transmit, to a UE, a joint beam refinement indication that indicates whether periodic CSI-RS resources in a CSI-RS resource set are associated with a beam refinement procedure associated with both the UE and the network node, as described above.

As further shown in FIG. 7, in some aspects, process 700 may include receiving, from the UE, a joint beam refinement report associated with the periodic CSI-RS resources in the CSI-RS resource set that is in accordance with the joint beam refinement indication (block 720). For example, the network node (such as by using communication manager 150 or reception component 902, depicted in FIG. 9) may receive, from the UE, a joint beam refinement report associated with the periodic CSI-RS resources in the CSI-RS resource set that is in accordance with the joint beam refinement indication, as described above.

Process 700 may include additional aspects, such as any single aspect or any combination of aspects described below or in connection with one or more other processes described elsewhere herein.

In a first additional aspect, the joint beam refinement indication is associated with a one-bit indicator in a CSI-RS resource set information element transmitted via radio resource control signaling that indicates whether a same spatial filter is to be applied for the periodic CSI-RS resources in the CSI-RS resource set across multiple periodic measurement periods.

In a second additional aspect, alone or in combination with the first aspect, the one-bit indicator indicates that the same spatial filter is to be applied for the periodic CSI-RS resources in the CSI-RS resource set across the multiple periodic measurement periods, and the joint beam refinement report is associated with the UE applying a different narrow reception beam, of multiple narrow reception beams associated with the UE, in each periodic measurement period, of the multiple periodic measurement periods.

In a third additional aspect, alone or in combination with one or more of the first and second aspects, the joint beam refinement indication is associated with a field in a CSI-RS resource set information element transmitted via radio resource control signaling that indicates whether the periodic CSI-RS resources in the CSI-RS resource set are associated with the beam refinement procedure associated with both the UE and the network node or only associated with the network node.

In a fourth additional aspect, alone or in combination with one or more of the first through third aspects, the field indicates that the periodic CSI-RS resources in the CSI-RS resource set are associated with the beam refinement procedure associated with both the UE and the network node, and the joint beam refinement report is associated with the UE applying a different narrow reception beam, of multiple narrow reception beams associated with the UE, in each periodic measurement period, of multiple periodic measurement periods associated with the periodic CSI-RS resources in the CSI-RS resource set.

In a fifth additional aspect, alone or in combination with one or more of the first through fourth aspects, process 700 includes transmitting, to the UE, configuration information indicating a reporting period associated with the joint beam refinement report, wherein the reporting period is associated with multiple periodic measurement periods for the periodic CSI-RS resources in the CSI-RS resource set.

In a sixth additional aspect, alone or in combination with one or more of the first through fifth aspects, the UE is associated with multiple narrow reception beams, and a quantity of the multiple periodic measurement periods is greater than or equal to a quantity of the multiple narrow reception beams.

In a seventh additional aspect, alone or in combination with one or more of the first through sixth aspects, process 700 includes receiving, from the UE, capability information indicating a quantity of narrow reception beams associated with the UE, wherein the reporting period is in accordance with the capability information.

In an eighth additional aspect, alone or in combination with one or more of the first through seventh aspects, process 700 includes receiving, from the UE, another report indicating a best SSB beam associated with the network node, wherein the joint beam refinement report is in accordance with the UE applying, after transmission of the other report, narrow reception beams quasi-colocated to the best SSB beam indicated by the other report.

In a ninth additional aspect, alone or in combination with one or more of the first through eighth aspects, process 700 includes receiving, from the UE, another report indicating a best SSB beam associated with the network node, wherein the periodic CSI-RS resources are quasi-colocated to the best SSB beam.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram of an example apparatus 800 for wireless communication that supports joint beam refinement procedures. The apparatus 800 may be a UE, or a UE may include the apparatus 800. In some aspects, the apparatus 800 includes a reception component 802, a transmission component 804, and a communication manager 806, which may be in communication with one another (for example, via one or more buses). As shown, the apparatus 800 may communicate with another apparatus 808 (such as a UE 120, a network node 110, or another wireless communication device) using the reception component 802 and the transmission component 804. The communication manager 806 may be included in, or implemented via, a processing system (for example, the processing system 140). In some aspects, the communication manager 806 is the communication manager 150.

In some aspects, the apparatus 800 may be configured to or operable to perform one or more operations described herein in connection with FIG. 5. Additionally or alternatively, the apparatus 800 may be configured to or operable to perform one or more processes described herein, such as process 600 of FIG. 6.

The reception component 802 may receive communications, such as reference signals, control information, or data communications, from the apparatus 808. The reception component 802 may provide received communications to one or more other components of the apparatus 800, such as the communication manager 806. In some aspects, the reception component 802 may perform signal processing on the received communications, and may provide the processed signals to the one or more other components in a similar manner as described above in connection with FIG. 1. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, or data communications, to the apparatus 808. In some aspects, the communication manager 806 may generate communications and may transmit the generated communications to the transmission component 804 for transmission to the apparatus 808. In some aspects, the transmission component 804 may perform signal processing on the generated communications, and may transmit the processed signals to the apparatus 808 in a similar manner as described above in connection with FIG. 1. In some aspects, the transmission component 804 may include one or more components of the UE described above in connection with FIG. 1, such as a radio, one or more RF chains, one or more transceivers, or one or more modems, each of which may in turn be coupled with one or more antennas of the UE. In some aspects, the transmission component 804 may be co-located with the reception component 802.

The communication manager 806 may receive or may cause the reception component 802 to receive a joint beam refinement indication that indicates whether periodic CSI-RS resources in a CSI-RS resource set are associated with a beam refinement procedure associated with both the UE and a network node. The communication manager 806 may transmit or may cause the transmission component 804 to transmit a joint beam refinement report associated with the periodic CSI-RS resources in the CSI-RS resource set that is in accordance with the joint beam refinement indication. In some aspects, the communication manager 806 may perform one or more operations described elsewhere herein as being performed by one or more components of the communication manager 806.

In some aspects, the communication manager 806 includes a set of components, such as a beamforming component 810, or a measurement component 812. Alternatively, the set of components may be separate and distinct from the communication manager 806. As used herein, the term “component” is intended to be broadly construed as hardware or a combination of hardware and at least one of software or firmware. In some aspects, one or more components of the set of components may include or may be implemented within a processing system (for example, the processing system 140). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The reception component 802 or the beamforming component 810 may receive a joint beam refinement indication that indicates whether periodic CSI-RS resources in a CSI-RS resource set are associated with a beam refinement procedure associated with both the UE and a network node. The transmission component 804 and/or the measurement component 812 may transmit a joint beam refinement report associated with the periodic CSI-RS resources in the CSI-RS resource set that is in accordance with the joint beam refinement indication.

The reception component 802 or the beamforming component 810 may receive configuration information indicating a reporting period associated with the joint beam refinement report, wherein the reporting period is associated with multiple periodic measurement periods for the periodic CSI-RS resources in the CSI-RS resource set.

The transmission component 804 or the beamforming component 810 may transmit capability information indicating a quantity of narrow reception beams associated with the UE, wherein the reporting period is in accordance with the capability information.

The transmission component 804 or the measurement component 812 may transmit another report indicating a best SSB beam associated with the network node, wherein the joint beam refinement report is in accordance with the UE applying, after transmitting the other report, narrow reception beams quasi-colocated to the best SSB beam indicated by the other report.

The transmission component 804 or the measurement component 812 may transmit another report indicating a best SSB beam associated with the network node, wherein the periodic CSI-RS resources are quasi-colocated to the best SSB beam.

The quantity and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

FIG. 9 is a diagram of an example apparatus 900 for wireless communication that supports joint beam refinement procedures. The apparatus 900 may be a network node, or a network node may include the apparatus 900. In some aspects, the apparatus 900 includes a reception component 902, a transmission component 904, and a communication manager 906, which may be in communication with one another (for example, via one or more buses). As shown, the apparatus 900 may communicate with another apparatus 908 (such as a UE 120, a network node 110, or another wireless communication device) using the reception component 902 and the transmission component 904. The communication manager 906 may be included in, or implemented via, a processing system (for example, the processing system 145). In some aspects, the communication manager 906 is the communication manager 155.

In some aspects, the apparatus 900 may be configured to or operable to perform one or more operations described herein in connection with FIG. 5. Additionally or alternatively, the apparatus 900 may be configured to or operable to perform one or more processes described herein, such as process 700 of FIG. 7.

The reception component 902 may receive communications, such as reference signals, control information, or data communications, from the apparatus 908. The reception component 902 may provide received communications to one or more other components of the apparatus 900, such as the communication manager 906. In some aspects, the reception component 902 may perform signal processing on the received communications, and may provide the processed signals to the one or more other components in a similar manner as described above in connection with FIG. 1. In some aspects, the reception component 902 may include one or more components of the network node described above in connection with FIG. 1, such as a radio, one or more RF chains, one or more transceivers, or one or more modems, each of which may in turn be coupled with one or more antennas of the network node.

The transmission component 904 may transmit communications, such as reference signals, control information, or data communications, to the apparatus 908. In some aspects, the communication manager 906 may generate communications and may transmit the generated communications to the transmission component 904 for transmission to the apparatus 908. In some aspects, the transmission component 904 may perform signal processing on the generated communications, and may transmit the processed signals to the apparatus 908 in a similar manner as described above in connection with FIG. 1. In some aspects, the transmission component 904 may include one or more components of the network node described above in connection with FIG. 1, such as a radio, one or more RF chains, one or more transceivers, or one or more modems, each of which may in turn be coupled with one or more antennas of the network node. In some aspects, the transmission component 904 may be co-located with the reception component 902.

The communication manager 906 may transmit or may cause the transmission component 904 to transmit, to a UE, a joint beam refinement indication that indicates whether periodic CSI-RS resources in a CSI-RS resource set are associated with a beam refinement procedure associated with both the UE and the network node. The communication manager 906 may receive or may cause the reception component 902 to receive, from the UE, a joint beam refinement report associated with the periodic CSI-RS resources in the CSI-RS resource set that is in accordance with the joint beam refinement indication. In some aspects, the communication manager 906 may perform one or more operations described elsewhere herein as being performed by one or more components of the communication manager 906.

In some aspects, the communication manager 906 includes a set of components, such as a configuration component 910, or a beamforming component 912. Alternatively, the set of components may be separate and distinct from the communication manager 906. As used herein, the term “component” is intended to be broadly construed as hardware or a combination of hardware and at least one of software or firmware. In some aspects, one or more components of the set of components may include or may be implemented within a processing system (for example, the processing system 145). Additionally or alternatively, one or more components of the set of components may be implemented at least in part as software stored in one or more memories (for example, the memory described with reference to FIG. 1). For example, a component (or a portion of a component) may be implemented as instructions or code stored in a non-transitory computer-readable medium and executable by the processing system to perform the functions or operations of the component.

The transmission component 904 or the configuration component 910 may transmit, to a UE, a joint beam refinement indication that indicates whether periodic CSI-RS resources in a CSI-RS resource set are associated with a beam refinement procedure associated with both the UE and the network node. The reception component 902 or the beamforming component 912 may receive, from the UE, a joint beam refinement report associated with the periodic CSI-RS resources in the CSI-RS resource set that is in accordance with the joint beam refinement indication.

The transmission component 904 or the configuration component 910 may transmit, to the UE, configuration information indicating a reporting period associated with the joint beam refinement report, wherein the reporting period is associated with multiple periodic measurement periods for the periodic CSI-RS resources in the CSI-RS resource set.

The reception component 902 or the beamforming component 912 may receive, from the UE, capability information indicating a quantity of narrow reception beams associated with the UE, wherein the reporting period is in accordance with the capability information.

The reception component 902 or the beamforming component 912 may receive, from the UE, another report indicating a best SSB beam associated with the network node, wherein the joint beam refinement report is in accordance with the UE applying, after transmission of the other report, narrow reception beams quasi-colocated to the best SSB beam indicated by the other report.

The reception component 902 or the beamforming component 912 may receive, from the UE, another report indicating a best SSB beam associated with the network node, wherein the periodic CSI-RS resources are quasi-colocated to the best SSB beam.

The quantity and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some Aspects of the present disclosure:

Aspect 1: A method for wireless communication by a user equipment (UE), comprising: receiving a joint beam refinement indication that indicates whether periodic channel state information reference signal (CSI-RS) resources in a CSI-RS resource set are associated with a beam refinement procedure associated with both the UE and a network node; and transmitting a joint beam refinement report associated with the periodic CSI-RS resources in the CSI-RS resource set that is in accordance with the joint beam refinement indication.

Aspect 2: The method of Aspect 1, wherein the joint beam refinement indication is associated with a one-bit indicator in a CSI-RS resource set information element received via radio resource control signaling that indicates whether a same spatial filter is to be applied for the periodic CSI-RS resources in the CSI-RS resource set across multiple periodic measurement periods.

Aspect 3: The method of Aspect 2, wherein the one-bit indicator indicates that the same spatial filter is to be applied for the periodic CSI-RS resources in the CSI-RS resource set across the multiple periodic measurement periods, and wherein the joint beam refinement report is associated with the UE applying a different narrow reception beam, of multiple narrow reception beams associated with the UE, in each periodic measurement period, of the multiple periodic measurement periods.

Aspect 4: The method of any of Aspects 1-3, wherein the joint beam refinement indication is associated with a field in a CSI-RS resource set information element received via radio resource control signaling that indicates whether the periodic CSI-RS resources in the CSI-RS resource set are associated with the beam refinement procedure associated with both the UE and the network node or only associated with network node.

Aspect 5: The method of Aspect 4, wherein the field indicates that the periodic CSI-RS resources in the CSI-RS resource set are associated with the beam refinement procedure associated with both the UE and the network node, and wherein the joint beam refinement report is associated with the UE applying a different narrow reception beam, of multiple narrow reception beams associated with the UE, in each periodic measurement period, of multiple periodic measurement periods associated with the periodic CSI-RS resources in the CSI-RS resource set.

Aspect 6: The method of any of Aspects 1-5, further comprising receiving configuration information indicating a reporting period associated with the joint beam refinement report, wherein the reporting period is associated with multiple periodic measurement periods for the periodic CSI-RS resources in the CSI-RS resource set.

Aspect 7: The method of Aspect 6, wherein the UE is associated with multiple narrow reception beams, and wherein a quantity of the multiple periodic measurement periods is greater than or equal to a quantity of the multiple narrow reception beams.

Aspect 8: The method of Aspect 6, further comprising transmitting capability information indicating a quantity of narrow reception beams associated with the UE, wherein the reporting period is in accordance with the capability information.

Aspect 9: The method of any of Aspects 1-8, further comprising transmitting another report indicating a best synchronization signal block (SSB) beam associated with the network node, wherein the joint beam refinement report is in accordance with the UE applying, after transmitting the other report, narrow reception beams quasi-colocated to the best SSB beam indicated by the other report.

Aspect 10: The method of any of Aspects 1-9, further comprising transmitting another report indicating a best synchronization signal block (SSB) beam associated with the network node, wherein the periodic CSI-RS resources are quasi-colocated to the best SSB beam.

Aspect 11: A method for wireless communication by a network node, comprising: transmitting, to a user equipment (UE), a joint beam refinement indication that indicates whether periodic channel state information reference signal (CSI-RS) resources in a CSI-RS resource set are associated with a beam refinement procedure associated with both the UE and the network node; and receiving, from the UE, a joint beam refinement report associated with the periodic CSI-RS resources in the CSI-RS resource set that is in accordance with the joint beam refinement indication.

Aspect 12: The method of Aspect 11, wherein the joint beam refinement indication is associated with a one-bit indicator in a CSI-RS resource set information element transmitted via radio resource control signaling that indicates whether a same spatial filter is to be applied for the periodic CSI-RS resources in the CSI-RS resource set across multiple periodic measurement periods.

Aspect 13: The method of Aspect 12, wherein the one-bit indicator indicates that the same spatial filter is to be applied for the periodic CSI-RS resources in the CSI-RS resource set across the multiple periodic measurement periods, and wherein the joint beam refinement report is associated with the UE applying a different narrow reception beam, of multiple narrow reception beams associated with the UE, in each periodic measurement period, of the multiple periodic measurement periods.

Aspect 14: The method of any of Aspects 11-13, wherein the joint beam refinement indication is associated with a field in a CSI-RS resource set information element transmitted via radio resource control signaling that indicates whether the periodic CSI-RS resources in the CSI-RS resource set are associated with the beam refinement procedure associated with both the UE and the network node or only associated with the network node.

Aspect 15: The method of Aspect 14, wherein the field indicates that the periodic CSI-RS resources in the CSI-RS resource set are associated with the beam refinement procedure associated with both the UE and the network node, and wherein the joint beam refinement report is associated with the UE applying a different narrow reception beam, of multiple narrow reception beams associated with the UE, in each periodic measurement period, of multiple periodic measurement periods associated with the periodic CSI-RS resources in the CSI-RS resource set.

Aspect 16: The method of any of Aspects 11-15, further comprising transmitting, to the UE, configuration information indicating a reporting period associated with the joint beam refinement report, wherein the reporting period is associated with multiple periodic measurement periods for the periodic CSI-RS resources in the CSI-RS resource set.

Aspect 17: The method of Aspect 16, wherein the UE is associated with multiple narrow reception beams, and wherein a quantity of the multiple periodic measurement periods is greater than or equal to a quantity of the multiple narrow reception beams.

Aspect 18: The method of Aspect 16, further comprising receiving, from the UE, capability information indicating a quantity of narrow reception beams associated with the UE, wherein the reporting period is in accordance with the capability information.

Aspect 19: The method of any of Aspects 11-18, further comprising receiving, from the UE, another report indicating a best synchronization signal block (SSB) beam associated with the network node, wherein the joint beam refinement report is in accordance with the UE applying, after transmission of the other report, narrow reception beams quasi-colocated to the best SSB beam indicated by the other report.

Aspect 20: The method of any of Aspects 11-19, further comprising receiving, from the UE, another report indicating a best synchronization signal block (SSB) beam associated with the network node, wherein the periodic CSI-RS resources are quasi-colocated to the best SSB beam.

Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.

Aspect 22: An apparatus for wireless communication at a device, the apparatus comprising one or more memories and one or more processors coupled to the one or more memories, the one or more processors configured to cause the device to perform the method of one or more of Aspects 1-20.

Aspect 23: An apparatus for wireless communication, the apparatus comprising at least one means for performing the method of one or more of Aspects 1-20.

Aspect 24: A non-transitory computer-readable medium storing code for wireless communication, the code comprising instructions executable by one or more processors to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

Aspect 26: A device for wireless communication, the device comprising a processing system that includes one or more processors and one or more memories coupled with the one or more processors, the processing system configured to cause the device to perform the method of one or more of Aspects 1-20.

Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

Aspect 28: A device comprising a processing system that includes one or more processors and one or more code-storing memories coupled with the one or more processors, the processing system configured to cause the device to perform the method of one or more of Aspects 1-20.

Aspect 29: A device comprising a processing system that includes processor circuitry and code-storing memory circuitry, the processing system configured to cause the device to perform the method of one or more of Aspects 1-20.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive a joint beam refinement indication that indicates whether periodic channel state information reference signal (CSI-RS) resources in a CSI-RS resource set are associated with a beam refinement procedure associated with both the UE and a network node; and
transmit a joint beam refinement report associated with the periodic CSI-RS resources in the CSI-RS resource set that is in accordance with the joint beam refinement indication.

2. The UE of claim 1, wherein the joint beam refinement indication is associated with a one-bit indicator in a CSI-RS resource set information element received via radio resource control signaling that indicates whether a same spatial filter is to be applied for the periodic CSI-RS resources in the CSI-RS resource set across multiple periodic measurement periods.

3. The UE of claim 2, wherein the one-bit indicator indicates that the same spatial filter is to be applied for the periodic CSI-RS resources in the CSI-RS resource set across the multiple periodic measurement periods, and wherein the joint beam refinement report is associated with the UE applying a different narrow reception beam, of multiple narrow reception beams associated with the UE, in each periodic measurement period, of the multiple periodic measurement periods.

4. The UE of claim 1, wherein the joint beam refinement indication is associated with a field in a CSI-RS resource set information element received via radio resource control signaling that indicates whether the periodic CSI-RS resources in the CSI-RS resource set are associated with the beam refinement procedure associated with both the UE and the network node or only associated with network node.

5. The UE of claim 4, wherein the field indicates that the periodic CSI-RS resources in the CSI-RS resource set are associated with the beam refinement procedure associated with both the UE and the network node, and
wherein the joint beam refinement report is associated with the UE applying a different narrow reception beam, of multiple narrow reception beams associated with the UE, in each periodic measurement period, of multiple periodic measurement periods associated with the periodic CSI-RS resources in the CSI-RS resource set.

6. The UE of claim 1, wherein the processing system is configured to cause the UE to receive configuration information indicating a reporting period associated with the joint beam refinement report,
wherein the reporting period is associated with multiple periodic measurement periods for the periodic CSI-RS resources in the CSI-RS resource set.

7. The UE of claim 6, wherein the UE is associated with multiple narrow reception beams, and
wherein a quantity of the multiple periodic measurement periods is greater than or equal to a quantity of the multiple narrow reception beams.

8. The UE of claim 6, wherein the processing system is configured to cause the UE to transmit capability information indicating a quantity of narrow reception beams associated with the UE,
wherein the reporting period is in accordance with the capability information.

9. The UE of claim 1, wherein the processing system is configured to cause the UE to transmit another report indicating a best synchronization signal block (SSB) beam associated with the network node,
wherein the joint beam refinement report is in accordance with the UE applying, after transmitting the other report, narrow reception beams quasi-colocated to the best SSB beam indicated by the other report.

10. The UE of claim 1, wherein the processing system is configured to cause the UE to transmit another report indicating a best synchronization signal block (SSB) beam associated with the network node,
wherein the periodic CSI-RS resources are quasi-colocated to the best SSB beam.

11. A method for wireless communication by a user equipment (UE), comprising:
receiving a joint beam refinement indication that indicates whether periodic channel state information reference signal (CSI-RS) resources in a CSI-RS resource set are associated with a beam refinement procedure associated with both the UE and a network node; and
transmitting a joint beam refinement report associated with the periodic CSI-RS resources in the CSI-RS resource set that is in accordance with the joint beam refinement indication.

12. The method of claim 11, wherein the joint beam refinement indication is associated with a one-bit indicator in a CSI-RS resource set information element received via radio resource control signaling that indicates whether a same spatial filter is to be applied for the periodic CSI-RS resources in the CSI-RS resource set across multiple periodic measurement periods.

13. The method of claim 12, wherein the one-bit indicator indicates that the same spatial filter is to be applied for the periodic CSI-RS resources in the CSI-RS resource set across the multiple periodic measurement periods, and
wherein the joint beam refinement report is associated with the UE applying a different narrow reception beam, of multiple narrow reception beams associated with the UE, in each periodic measurement period, of the multiple periodic measurement periods.

14. The method of claim 11, wherein the joint beam refinement indication is associated with a field in a CSI-RS resource set information element received via radio resource control signaling that indicates whether the periodic CSI-RS resources in the CSI-RS resource set are associated with the beam refinement procedure associated with both the UE and the network node or only associated with network node.

15. The method of claim 14, wherein the field indicates that the periodic CSI-RS resources in the CSI-RS resource set are associated with the beam refinement procedure associated with both the UE and the network node, and
wherein the joint beam refinement report is associated with the UE applying a different narrow reception beam, of multiple narrow reception beams associated with the UE, in each periodic measurement period, of multiple periodic measurement periods associated with the periodic CSI-RS resources in the CSI-RS resource set.

16. The method of claim 11, further comprising receiving configuration information indicating a reporting period associated with the joint beam refinement report,
wherein the reporting period is associated with multiple periodic measurement periods for the periodic CSI-RS resources in the CSI-RS resource set.

17. The method of claim 16, wherein the UE is associated with multiple narrow reception beams, and
wherein a quantity of the multiple periodic measurement periods is greater than or equal to a quantity of the multiple narrow reception beams.

18. The method of claim 16, further comprising transmitting capability information indicating a quantity of narrow reception beams associated with the UE,
wherein the reporting period is in accordance with the capability information.

19. The method of claim 11, further comprising transmitting another report indicating a best synchronization signal block (SSB) beam associated with the network node,
wherein the joint beam refinement report is in accordance with the UE applying, after transmitting the other report, narrow reception beams quasi-colocated to the best SSB beam indicated by the other report.

20. An apparatus for wireless communication, comprising:
means for receiving a joint beam refinement indication that indicates whether periodic channel state information reference signal (CSI-RS) resources in a CSI-RS resource set are associated with a beam refinement procedure associated with both the apparatus and a network node; and
means for transmitting a joint beam refinement report associated with the periodic CSI-RS resources in the CSI-RS resource set that is in accordance with the joint beam refinement indication.
